(19) United States
(12) Patent Application Publication
(10) Pub. No.: US 2024/0080084 A1
(43) Pub. Date: Mar. 7, 2024

(54) TECHNOLOGIES FOR BEAM MANAGEMENT USING A HYBRID BEAMFORMING ARCHITECTURE

(71) Applicant: Apple Inc., Cupertino, CA (US)

(72) Inventors: Wanlu Sun, San Diego, CA (US); Sharad Sambhwani, San Diego, CA (US); Sung-En Chiu, San Diego, CA (US)

(73) Assignee: Apple Inc., Cupertino, CA (US)

(21) Appl. No.: 18/456,388

(22) Filed: Aug. 25, 2023

Related U.S. Application Data
(60) Provisional application No. 63/403,645, filed on Sep. 2, 2022.

(51) Int. Cl. H04B 7/06; H04B 7/0456

(52) U.S. Cl. CPC H04B 7/06966; H04B 7/0456

(57) ABSTRACT

The present application relates to devices and components including apparatus, systems, and methods for beam management using a hybrid beamforming architecture.

### RELATED APPLICATION

This application claims priority to U.S. Provisional Patent Application No. 63/403,645, filed Sep. 2, 2022, which is hereby incorporated by reference in its entirety.

### FIELD

This disclosure is related to the field of radio access networks and, in particular, to technologies for beam management using a hybrid beamforming architecture.

### BACKGROUND

Third Generation Partnership Project (3GPP) Technical Specifications (TSs)

define standards for radio access networks. These TSs describe aspects related to managing beams for communications between nodes of these radio access networks.

### BRIEF DESCRIPTION OF THE DRAWINGS

FIG. 1 illustrates a network environment in accordance with some

embodiments.

FIG. 2 illustrates hybrid beamforming architectures in accordance with some embodiments.

FIG. 3 illustrates a signaling diagram in accordance with some embodiments.

FIG. 4 illustrates a hybrid beamforming architecture in accordance with some

embodiments.

FIG. 5 illustrates a radiation pattern in accordance with some embodiments.

FIG. 6 is a plot of composite radiation gain patterns in accordance with some embodiments.

FIG. 7 illustrates another hybrid beamforming architecture in accordance with some embodiments.

FIG. 8 illustrates another radiation pattern in accordance with some embodiments.

FIG. 9 illustrates another hybrid beamforming architecture in accordance with

some embodiments.

FIG. 10 illustrates a beamforming management-reference signal transmission in accordance with some embodiments.

FIG. 11 illustrates an operational flow/algorithmic structure in accordance with some embodiments.

FIG. 12 illustrates another operational flow/algorithmic structure in accordance with some embodiments.

FIG. 13 illustrates a user equipment in accordance with some embodiments.

FIG. 14 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a

physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

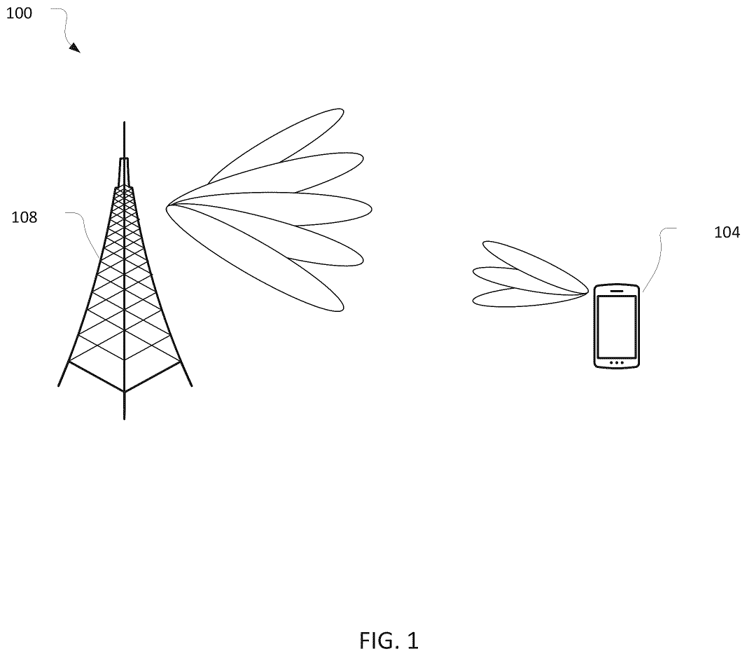

FIG. 1 illustrates a network environment 100 in accordance with some embodiments. The network environment 100 may include a user equipment (UE) 104 communicatively coupled with a base station 108 of a radio access network (RAN). The UE 104 and the base station 108 may communicate over air interfaces compatible with 3GPP TSs such as those that define a Fifth Generation (5G) new radio (NR) system or a later system (for example, a Sixth Generation (6G) radio system). The base station 108 may provide user plane and control plane protocol terminations toward the UE 104.

The UE 104 and the base station 108 may each include an array of antenna elements in one or more antenna panels that allow receive or transmit beamforming. Beamforming may improve the uplink and downlink budgets by determining and using uplink and downlink beams that increase antenna gain and overall system performance. The UE 104 and the base station 108 may determine desired uplink-downlink beam pairs using beam management (BM) operations based on reference signal measurements and channel reciprocity assumptions.

Various beamforming architectures may exist. For example, a pure analog beamforming architecture may include all antenna elements connected to one radio-frequency (RF) chain via phase shifters. For another example, a pure digital beamforming architecture may include each antenna element connected to a dedicated RF chain. In some embodiments, the UE 104 or the base station 108 may include a hybrid beamforming architecture that is a combination of the analog and digital beamforming architectures.

The hybrid beamforming architecture may capitalize on the benefits of both digital and analog beamforming and may achieve a good tradeoff between performance and implementation costs. The hybrid beamforming architecture may be particularly suitable for higher frequency bands in which a large number of antennas are deployed.

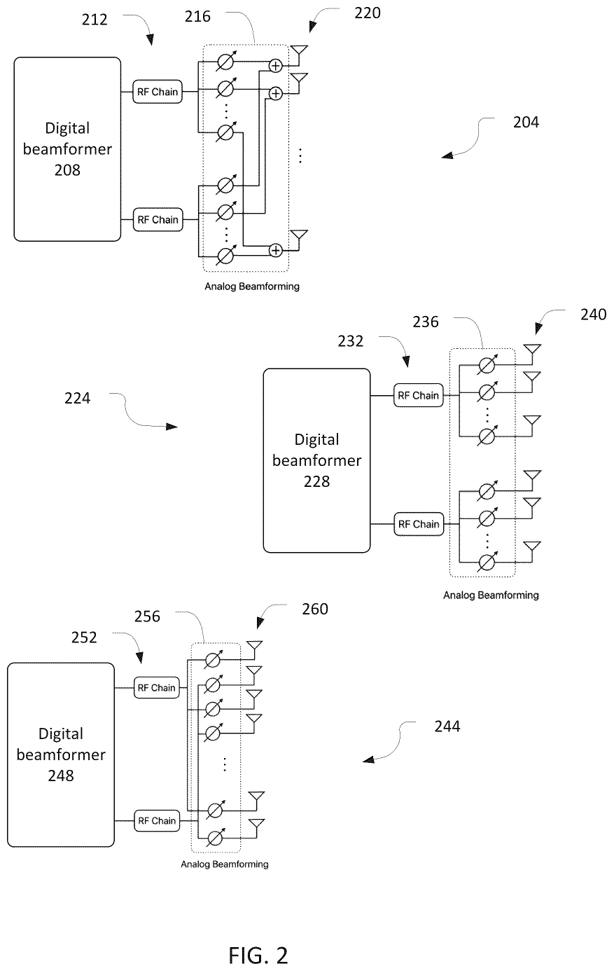

FIG. 2 illustrates three hybrid beamforming architectures that may be used in various embodiments.

Architecture 204 may represent a generalized hybrid beamforming architecture in which a digital beamformer 208 is coupled with two RF chains 212. The two RF chains 212 are coupled with a phase-shifter network 216 that provides analog beamforming. In general, and as used herein, the digital beamformer 208 may apply a precoder from a set of precoders for the digital domain beamforming, while the analog beamformer (e.g., the phase-shifter network 216) may apply a beamformer from a set of beamformers for the analog domain beamforming. The application of the precoder and beamformer may result in the Tx beam.

The phase-shifter network 216 may include phase shifters coupled with summation elements as shown. Each summation element may be coupled with a corresponding antenna element of antenna elements 220.

The architecture 204 is referred to as a “generalized” architecture in that its phase shifters may be selectively turned off, which may result in the input provided to an associated summation element being set to zero. By turning off different phase shifters, the architecture 204 may transform into architecture 224 or architecture 244.

Architecture 224 may represent a first subarray-based hybrid beamforming architecture that includes a digital beamformer 228, RF chains 232, a phase-shifter network 236, and antenna elements 240 coupled with one another at least as shown. In architecture 224, each RF chain is coupled to a distinct set of phase shifters of the phase-shifter network 236, and each phase shifter is coupled with a respective antenna element.

Architecture 244 may represent a second subarray-based hybrid beamforming architecture that includes a digital beamformer 248, RF chains 252, phase-shifter network 256, and antenna elements 260 coupled with one another at least as shown. In architecture 244, each RF chain is coupled to a distinct set of phase shifters of the phase-shifter network 236, and each phase shifter is coupled with a respective antenna element. In contrast to architecture 224, architecture 244 includes one RF chain coupled with antenna elements interleaved with antenna elements coupled with the other RF chain.

Beam management is a key enabler for communications in frequency range 2 (FR2) and above. Beam management may be used to identify and maintain desired beams for transmissions between the base station 108 and the UE 104. A set of procedures used for downlink beam management may be referred to as P1, P2, and P3. P1 is used as an initial access type of beam determination in which the base station 108 and the UE 104 have no prior knowledge of the best serving beam. In P1, the base station 108 performs beam sweeping and transmits synchronization signal and physical broadcast channel blocks (SSBs) in beams. At the end of the P1 procedure, the UE 104 may find a transmit (Tx) beam of the base station 108 that provides good link quality in terms of layer 1 (L1)-reference signal received power (RSRP). The UE 104 may also select a receive (Rx) beam during the P1 procedure. The P2 procedure may be used to refine the Tx beam of the base station 108. In the P2 procedure, the base station 108 may send out a channel state information-reference signal (CSI-RS) in a beam-sweeping operation. The P3 procedure may be used to identify the desired Rx beam at the UE 104. The P3 procedure may include the base station 108 transmitting the same beam over time and the UE 104 using the repeated Tx beams in an Rx beam sweeping process to find the desired Rx beam.

As described above, the UE 104 completes beam measurement and selection based upon the transmission of SSBs/CSI RSs and the measured L1-RSRP. In case of SSBs, the base station 108 transmits each SSB using a single logical antenna port. Then the UE 104 measures the L1-RSRP based on the resource elements that carry secondary synchronization signals (SSS), which is a part of the SSB. In NR, the SSS is a gold sequence that is generated as a product of two sequences that depend on both the pointer towards the physical layer cell identifier (PCI) group (1 out of 336) and the pointer towards the PCI within the group (1 out of 3). Thus, there may be 1008 SSS sequences. The 1008 sequences may be selected so that they have good cross-correlation property, e.g., low cross-correlation, which may be utilized for cell search. In addition, the demodulation reference signal (DMRS) of the PBCH in SSB may be used for RSRP measurement as well.

In the case of CSI RS, the L1-RSRP may be measured based on the resource elements that carry the CSI RS. Furthermore, according to current standards, the UE 104 may be configured with what CSI quantities/parameters to report, where beam management related report configurations include cri-RSRP, ssb-Index-RSRP, cri-RSRP-Capability[Set]Index, and ssb-Index-RSRP-Capability[Set]Index. Here ‘cri’ stands for CSI-RS Resource Indicator.

Current beam management solutions usually assume an analog beamforming architecture at the base station. When a hybrid beamforming architecture is exploited, the current beam management framework can still be used through two options.

In a first option, a precoder of all 1s is always applied in digital domain. This may reduce to the legacy analog beamforming-based beam management. Consider, for example, an SSS transmission via the architecture 224. If the digital beamformer 228 applies all is to the SSS, the architecture 224 may operate in an identical manner as a traditional analog beamforming architecture having one RF chain coupled with all the phase shifters/antenna elements. If an analog codebook has M beamformers, the device may need M time instances to perform a beam sweeping operation.

In a second option, in addition to the conventional analog codebook of M beamformers, a digital codebook of M₂ candidate precoders may also be defined. With this option, beam sweeping may be performed across both analog and digital codebooks. This may result in a total of M×M₂ beams to sweep. This option provides more beam candidates and can result in selecting a more suitable beam. However, the beam sweeping operation may require M×M₂ time instances, which may be significantly larger than the legacy analog beamforming-based beam management.

Building on 5G, the forthcoming 6G networks will continue to evolve to enhance overall system performance and user experience. In addition to the typical 5G spectrum (for example, FR1 and FR2), networks will evolve to encompass upper mid bands (7 GHz-24 GHz) and sub-THz bands (100 GHz-300 GHz). For higher frequency bands, high gain and narrow beam based data transmission may be used to address severe propagation loss. This may require a large number of antennas.

For beam sweeping, typically the beams are selected from a predefined analog codebook, where the different beamformers from the codebook point in different directions so that the entire interested range in the angular domain can be covered. When there is a large number of antennas, the number of analog/hybrid beamformers in the codebook becomes large as well. As a result, the beam sweeping procedure can be very time consuming using current beam management framework. Hence, identifying the best beam across large number of beam candidates with lower latency is an important but challenging design aspect of the beam management framework.

Embodiments of the present disclosure provide efficient beam management for devices that employ a hybrid beamforming architecture. In this manner, a transmitter may find a desirable Tx beam in a time duration shorter than that associated with legacy devices. The identified beam may then be used for later (data) transmissions by the transmitter.

Various aspects described herein provide for beam management procedures, BM codebook construction and selection; beam management-reference signal (BM-RS) transmission; BM measurement and report; and Tx beam determination at the transmitter.

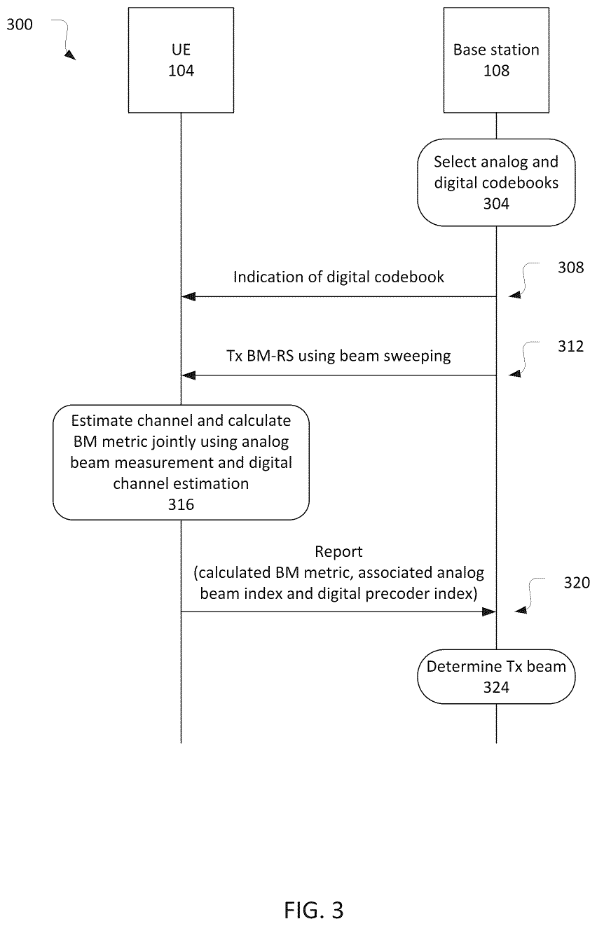

FIG. 3 is a signaling diagram 300 illustrating a beam management procedure in accordance with some embodiments. The signaling diagram 300 may be used to introduce aspects of the beam management procedure at a high level, with further details of the aspects provided elsewhere herein.

The signaling diagram 300 may include, at 304, the base station 108 selecting analog and digital codebooks. The base station 108, which may employ a hybrid beamforming architecture, may select an analog codebook [symbol] ={b₁, b₂, . . . , b_{M}_{₁}} with M₁ beamformers and a digital codebook [symbol] ={p₁, p₂, . . . , p_{M}_{₂}} with M₂ precoders.

At 308, the base station 108 may provide an indication of the selected digital codebook to the UE 104.

At 312, the base station 108 may perform beam sweeping only across the M₁ beamformers in the analog codebook [symbol] . For example, the base station 108 may transmit a BM-RS using beam transmissions based on each of the M₁ beamformers in the analog codebook [symbol] . The BM-RS may be the reference signal used for beam management (for example, SSS, DMRS for PBCH, or CSI-RS). For each beam transmission, the transmitter of the base station 108 may send (pseudo-)orthogonal BM-RS sequences across the RF chains. Transmitting the (pseudo-)orthogonal BM-RS sequences using analog beam sweeping in this manner may allow the receiver to determine both the desired analog beamformer and the desired digital precoder.

At 316, the receiver of the UE 104 may estimate a channel using the (pseudo-) orthogonal BM-RS sequences. The receiver may then calculate a BM metric jointly using analog beam measurement and digital channel estimation.

At 320, the UE 104 may send a report to the base station 108. The report may include the calculated BM metric along with the associated analog beam index and the digital precoder index.

At 324, the transmitter of the base station 108 may determine the Tx beam to use for a later transmission based on the received report.

While the signaling diagram 300 shows the base station 108 as the transmitting device and the UE 104 as the receiving device, in other embodiments, these roles may be reversed.

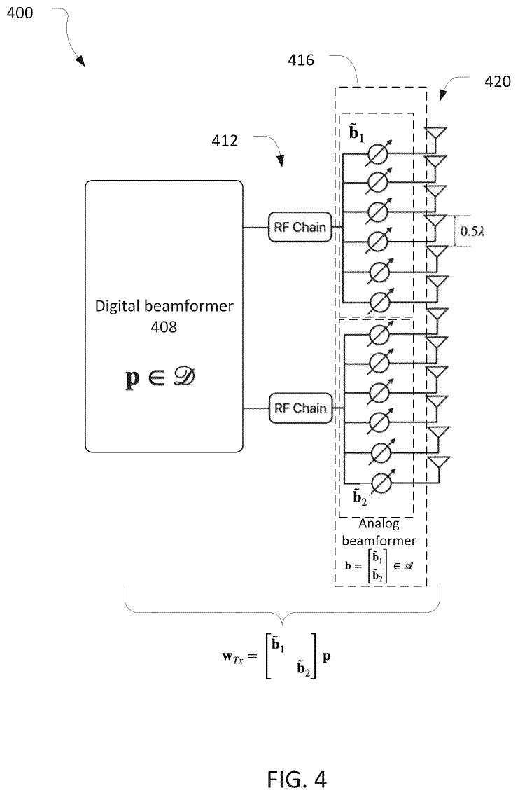

FIG. 4 illustrates a hybrid beamforming architecture 400 in accordance with some embodiments, the architecture 400 may be similar to architecture 224 of FIG. 2. The architecture 400 may be used to illustrate concepts of the precoding and beamforming introduced above in accordance with some embodiments.

The architecture 400 may include a digital beamformer 408, RF chains 412, a phase-shifter network 416, and antenna elements 420 coupled with one another at least as shown. The architecture 400 may include 12 antenna elements (e.g., N=12) and two RF chains (e.g., N_{RF}=2). The distance between adjacent antenna elements may be 0.5 λ where λ is the wavelength.

With the hybrid beamforming architecture 400, the analog codebook may be defined as [symbol] ={b₁, b₂, . . . , b_{M}_{₁}} with M₁ beamformers and the digital codebook [symbol] ={p₁, p₂, . . . , p_{M}_{₂}} may be defined with M₂ precoders. The best Tx beam is determined by jointly using the analog and digital codebooks with where

$${w}_{Tx} = [ \begin{matrix}{\tilde{b}}_{1} & & & \\ & {\tilde{b}}_{2} & & \\ & & … & \\ & & & {\tilde{b}}_{{N}_{RF}}\end{matrix} ] p ,$$

where w_{Tx} is the beamforming weights of the determined Tx beam, p is the selected digital precoder from codebook [symbol] , and \tilde{b}ᵢ is a column vector consisting of the phase shifters of the antennas associated with the i^{th} RF chain. Thus, the selected analog beamformer from codebook [symbol] is

$$b = [ \begin{matrix}{\tilde{b}}_{1} \\ … \\ {\tilde{b}}_{{N}_{RF}}\end{matrix} ] .$$

As shown in FIG. 4, the digital precoder is p, the analog beamformer is

$$b = [ \begin{matrix}{\tilde{b}}_{1} \\ {\tilde{b}}_{2}\end{matrix} ]$$

given the two RF chains, and the beamforming weights of the determined Tx beam is

$${w}_{Tx} = [ \begin{matrix}{\tilde{b}}_{1} & \\ & {\tilde{b}}_{2}\end{matrix} ] p .$$

The transmitting device may perform analog beam sweeping only across the M₁ beamformers in the analog codebook [symbol] . Nevertheless, the receiver may use this analog beam sweeping to determine not only the selected analog beamformer, but also the selected digital precoder. The joint selection of analog beamformer and digital precoder may be enabled by sending (pseudo-)orthogonal BM-RS sequences across the RF chains, where BM-RS denotes the reference signal used for beam management.

Some aspects of the present disclosure provide for construction and selection of the BM codebooks.

For purposes of explanation, consider a conventional analog codebook [symbol] with M beamformers that uses discrete Fourier transform (DFT)-based codebook with oversampling rate O. In this case, M=ON and [symbol] ={c₁, c₂, . . . c_{M}}, where cᵢ is the l-th analog beamformer with

$${c}_{l} = {[ 1 , {e}^{- j \frac{2 π ( l - 1 )}{ON}} , … , {e}^{- j \frac{2 π ( l - 1 ) ( N - 1 )}{ON}} ]}^{T}$$

and l∈{1, 2, . . . , M}.

In some embodiments, M₁<M so that beam sweeping time is reduced to M₁. With a hybrid beamforming architecture, one option is to define M₁=M/N_{RF}. The analog codebook [symbol] may be constructed so that, via jointly considering the analog codebook [symbol] and the digital codebook [symbol] , the achieved composite radiation gain pattern is similar to that achieved with the conventional analog codebook including M beamformers. A composite radiation gain pattern, as used herein, may refer to a maximum over all the gain patterns of the beams, which indicates the wellness of the spherical coverage of the codebook(s). Moreover, the combination of [symbol] and [symbol] leads to M₁M₂ hybrid beams. If M₁M₂>M, the number of beam candidates is higher compared to the conventional beam management, which leads to the possible selection of a more suitable beam. Thus, more beam candidates may be evaluated using a shorter beam sweeping time.

In other embodiments, M₁=M so the same beam sweeping time is kept. In some embodiments, the proposed analog codebook [symbol] can be the same as the conventional analog codebook [symbol] . Using the aspects of the present disclosure to jointly consider the analog codebook [symbol] and the digital codebook [symbol] , may provide more beam candidates (e.g., increased from M to M₁M₂), and may also improve the composite radiation gain pattern.

In some embodiments, the digital codebook [symbol] ={p₁, p₂, . . . , p_{M}_{₂}} may be constructed as a co-phasing based codebook. For example, pᵢ=[1, e^{-j2πϕ}^{ᵢ}, . . . , e^{-j2πϕ}^{ᵢ}^{(N}^{_{RF}}⁻¹⁾]^{T} for i∈{1, 2, . . . , M₂}m, where φᵢ∈[0,1) denotes the co-phasing factor for the i^{th} precoder.

In other embodiments, the digital codebook [symbol] ={p₁, p₂, . . . , p_{M}_{₂}} may be constructed as a DFT-based digital codebook, where

$${p}_{i} = {[ 1 , {e}^{- j \frac{2 π ( i - 1 )}{{ON}_{RF}}} , … , {e}^{- j \frac{2 π ( i - 1 ) ( {N}_{RF} - 1 )}{{ON}_{RF}}} ]}^{T}$$

i∈{1, 2, . . . , M₂}, O is the oversampling rate and M₂=ON_{RF}.

The construction of the analog codebooks may depend on the underlying architecture of hybrid beamforming. Some examples are given below with respect to some specific architectures; however, similar concepts may be applied to other hybrid beamforming architures in a similar manner.

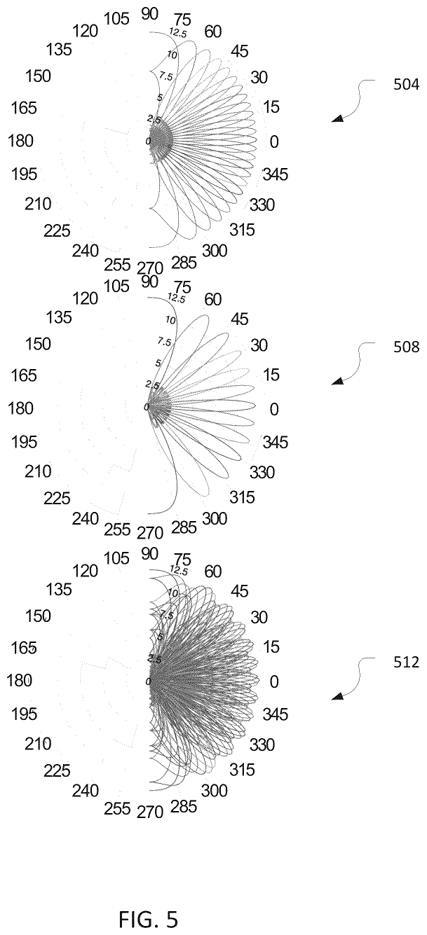

If the architecture 400 were used with a conventional DFT-based codebook as the analog codebook and O=2, the architecture 400 may generate M₁=24 beams as shown in radiation pattern 504 of FIG. 5. Using a conventional DFT-based codebook as the analog codebook and O=1, the architecture 400 may generate M₁=12 beams as shown in radiation pattern 508 of FIG. 5.

Using the architecture 400 with the joint digital/analog codebook as described herein, M₁=12, which may correspond to 12 beams to sweep in a beam sweeping operation. The digital beamformer 408 may use a co-phasing based digital codebook including M₂=8 precoders with [ϕ₁, ϕ₂, . . . , ϕ₈]=[0, 1, . . . , 7]/8. The joint use of digital precoder and analog beamformer may result in a total M₁×M₂=96 hybrid beams, all of which can be measured and evaluated by the receiver. Radiation pattern 512 of FIG. 5 illustrates the 96 hybrid beams that may be generated using the joint digital/analog codebook in accordance with some embodiments.

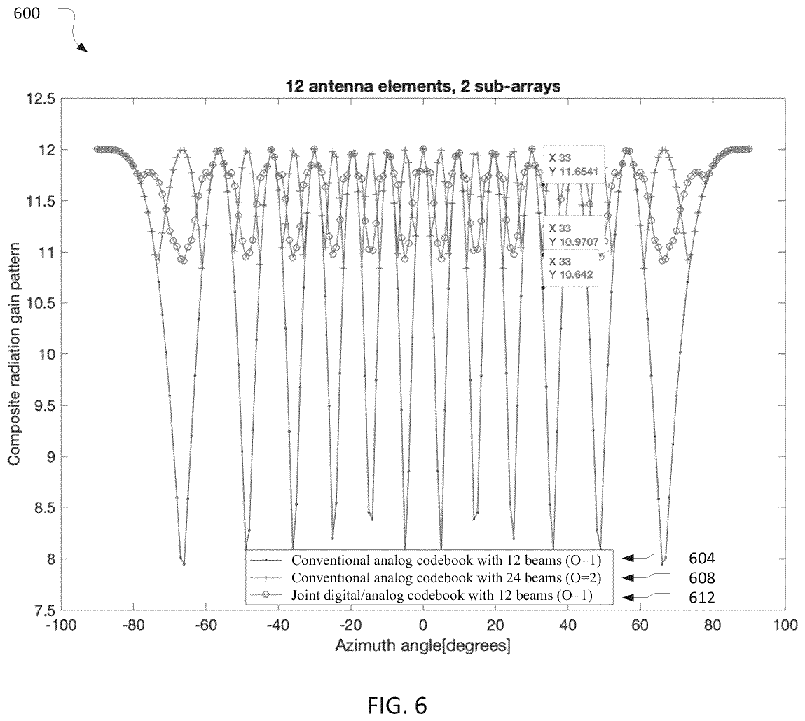

FIG. 6 is a plot 600 with composite radiation gain patterns of generated beams for different schemes in accordance with some embodiments. The composite radiation gain pattern may be defined as the maximum over gain patterns of all beams on any given angle, which indicates the wellness of the spherical coverage of the codebook(s). Plot 600 includes a pattern 604 corresponding to a conventional analog codebook with 12 beams (O=1); a pattern 608 corresponding to a conventional analog codebook with 24 beams (O=2); and a pattern 612 corresponding to a joint digital/analog codebook with 12 beams (O=1) in accordance with embodiments of the present disclosure.

As shown, a conventional codebook with 24 beams may yield a good composite radiation gain pattern; however, it requires 24 time instances to sweep over its beams. While its performance in terms of composite radiation gain pattern may be similar to the joint digital/analog codebook, it also needs twice the sweeping time, for example, 24 time instances as opposed to 12 time instances used for the joint digital/analog codebook.

The conventional codebook with 12 beams requires 12 time instances for beam sweeping. However, it shows significant degradation in the composite radiation gain pattern, e.g., spherical coverage at certain angles as compared to the joint digital/analog codebook.

Furthermore, the joint digital/analog codebook yields more beam candidates than either of the conventional solutions. For example, the joint digital/analog codebook has M₁×M₂=96 beam candidates as compared to either 12 or 24 beam candidates of the conventional solutions. In this way, a more suitable beam can be selected as compared to the conventional solutions.

The advantages of the proposed embodiments come from the fact that for each analog beam transmitted in one beam sweeping instance, the receiver is able to measure and evaluate M₂ different composite beams that result from joint digital precoding and analog beamforming.

As shown in FIG. 6, if a receiver is located at the 33-degree direction with respect to the transmitter, then the conventional codebook with 12 beams may need 12 time instances to find the best Tx beam with a directivity of 10.64; the conventional codebook with 24 beams may need 24 time instances to find the best Tx beam with a directivity of 10.97; and the joint digital/analog codebook may need 12 time instances to find the best Tx beam with a directivity of 11.65.

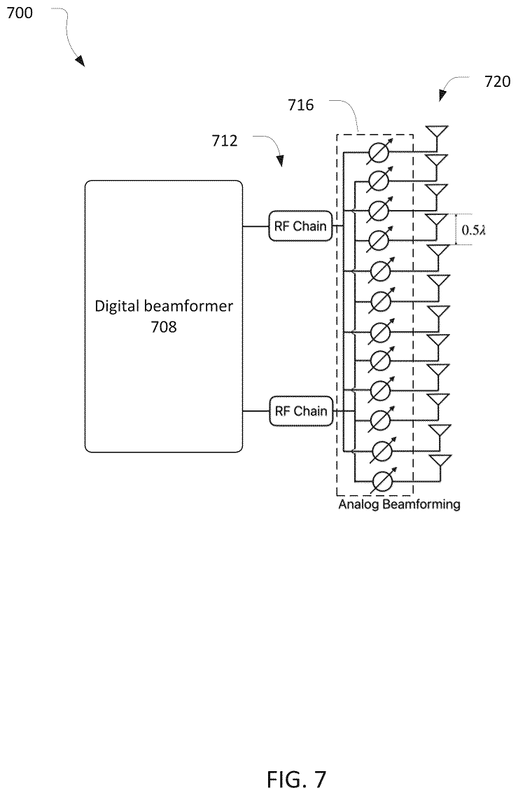

FIG. 7 illustrates a hybrid beamforming architecture 700 in accordance with some embodiments, the architecture 700 may be similar to architecture 244 of FIG. 2. The architecture 700 may include a digital beamformer 708, RF chains 712, a phase-shifter network 716, and antenna elements 720 coupled with one another at least a shown.

The architecture 400 may include 12 antenna elements (e.g., N=12) and two RF chains (e.g., N_{RF}=2). The distance between adjacent antenna elements may be 0.5 λ where λ is the wavelength.

Using a conventional DFT-based codebook as the analog codebook and O=1, the architecture 700 may generate M₁=12 beams as shown in radiation pattern 504 of FIG. 5. Thus, a beam sweeping operation may take 12 time instances.

In some embodiments, the architecture 700 may be used with the joint digital/analog codebook as described herein in which M₁=6, O=1 for DFT-based analog codebook, and [ϕ₁, ϕ₂, . . . , ϕ₈]=[0, 1, . . . , 7]/8 for a co-phasing based digital codebook. In this embodiment, there may be six analog beams to sweep during a beam sweeping operation.

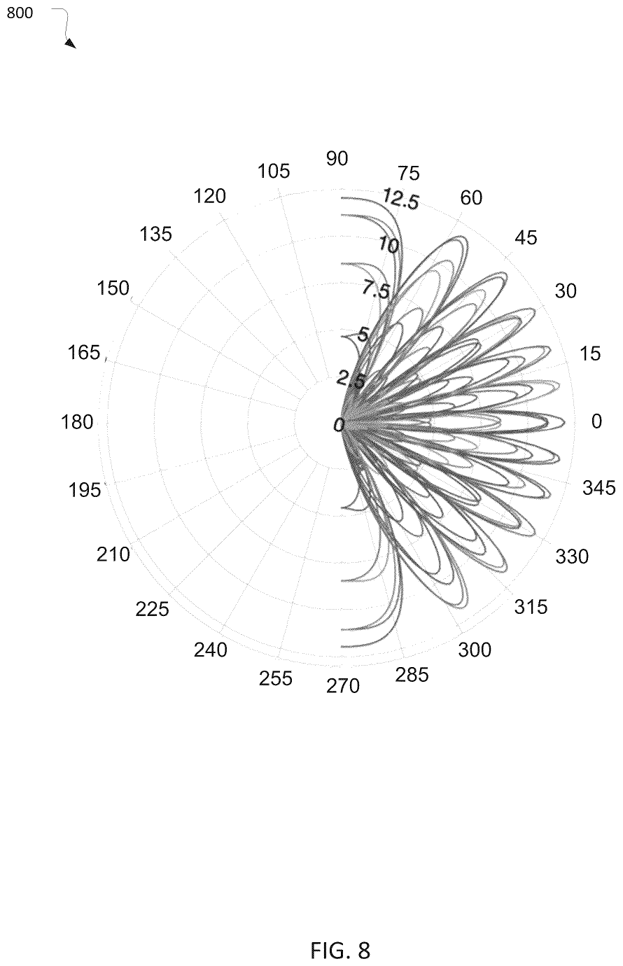

On the other hand, due to the joint use of digital precoder and analog beamformer, a total of M₁×M₂=48 hybrid beams may be measured and evaluated by the receiver. Radiation pattern 800 of FIG. 8 shows the 48 beams in accordance with some embodiments. The generated beams of the conventional analog codebook and the joint digital/analog codebook of this embodiment may have similar performance in terms of composite radiation gain pattern; however, the joint digital/analog codebook may only need half of the sweeping time, e.g., 6 time instances as opposed to 12 time instances.

Different codebooks have different characteristics. For example, some codebooks may generate single-beam transmissions while other codebooks may generate multi-beam transmissions. A transmitter may select appropriate analog and digital codebooks depending on a target scenario, antenna architecture, and transmission objectives. For example, the transmitter may select a codebook with single-beam transmissions when channels are sparse (e.g., line of sight (LoS) channels), and may select a codebook with multi-beam transmissions for rich scattering channels (e.g., non-line-of-sight (NLoS) channels). Also, the transmitter may select a codebook with single-beam transmissions when it targets single-layer data transfer, while select a codebook with multi-beam transmissions when it targets multi-layer data transfer.

The selection of analog codebook may be transparent to the receiver. On the other hand, the receiver should be aware of the applied digital codebook. The transmitter may provide the receiver with an indication of the applied digital codebook through explicit or implicit signaling.

If a legacy single-port BM-RS is used to estimate the NRF digital channels for

the NRF RF chains respectively, the same BM-RS and Tx analog beam may need to repeat NRF more times, each being sent from one one RF chain. This may result in a large increase the BM latency. Embodiments of the present disclosure describe BM-RS transmission in a manner that enables a reduction in the BM time duration as compared to current legacy BM-RS transmissions.

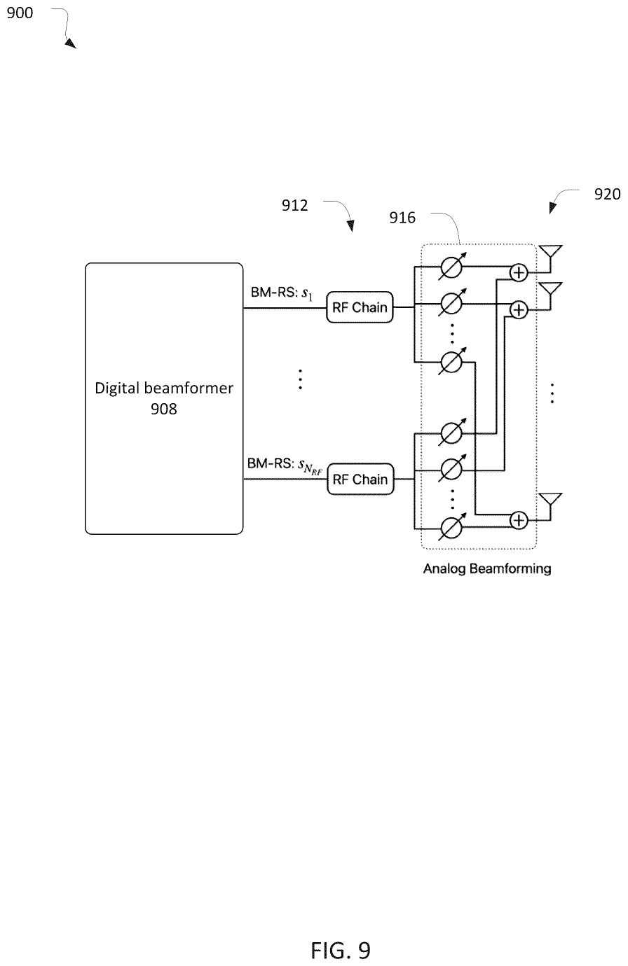

In some embodiments, the transmitter may send (pseudo-)orthogonal BM-RS sequences, e.g., s₁, s₂, . . . , S_{N_RF}, across different RF chains. FIG. 9 illustrates a hybrid beamforming architecture 900 in accordance with some embodiments. The architecture 900 may be similar to the generalized architecture 204 described above with respect to FIG. 2. The architecture 900 may include a digital beamformer 908, RF chains 912, phase shifting network 916, and antenna elements 920 coupled with one another at least as shown.

The digital beamformer 908 may provide the (pseudo-)orthogonal BM-RS sequences: BM-RS: s₁ . . . BM-RS:_{SN_RF}, to the RF chains. The (pseudo-)orthogonality can be achieved through time, frequency, or code domain.

If a single-port SSS transmission is used for BM, one SSS sequence may be extended into multiple (for example, N_{RF}) (pseudo-)orthogonal SSS sequences that may be respectively applied to the N_{RF} RF chains. As a result, BM latency may not be increased due to BM-RS transmission. Extending the SSS sequences across the RF chains in this manner may not only enable the beam management solutions of various embodiments but may also maintain usage of the SSS for other purposes, e.g., cell search. In other words, there is no ambiguity between an SSS's (pseudo-)orthogonal extension and another SSS.

In some embodiments, the transmitter may apply an orthogonal cover code (OCC) to an SSS sequence to extend it to N_{RF} (pseudo-)orthogonal SSS sequences. For example, when N_{RF}=2, an OCC of length 2 may be used, e.g.,

$${OCC}_{2} = [ \begin{matrix}1 & 1 \\ 1 & - 1\end{matrix} ] ;$$

when N_{RF}=4, an OCC of length 4 may be used, e.g.,

$${OCC}_{4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] .$$

In some embodiments, the transmitter may apply space frequency block coding (SFBC) to an SSS sequence to extend it to N_{RF} (pseudo-)orthogonal SSS sequences. Consider an SSS sequence [s_{1,1}, s_{1,2}, . . . , s_{1,L}] where L is the sequence length. If N_{RF}=2, the first RF chain transmits the original SSS sequence [s_{1,2}, s_{1,2}, s_{1,3}, s_{1,4}, . . . , s_{1,L-1}, s_{1,L}], while the second RF chain transmits:

$$\{ \begin{matrix}[ - {s}_{1 , 2}^{*} , {s}_{1 , 1}^{*} , - {s}_{1 , 4}^{*} , {s}_{1 , 3}^{*} , … , - {s}_{1 , L}^{*} , {s}_{1 , L - 1}^{*} ] & ifLis even \\ [ - {s}_{1 , 2}^{*} , {s}_{1 , 1}^{*} , - {s}_{1 , 4}^{*} , {s}_{1 , 3}^{*} , … , {s}_{1 , L - 2}^{*} , {s}_{1 , L} ] & ifLis odd\end{matrix} ,$$

where (.)* denotes the conjugate.

In embodiments in which a single-port PBCH DMRS is used for RSRP measurement in beam management, one PBCH DMRS sequence may be extended into multiple (for example, N_{RF}) (pseudo-)orthogonal PBCH DMRS sequences that are applied to the respective N_{RF} RF chains. Extending the DMRS sequences across the RF chains in this manner may not only enable the beam management solutions of various embodiments but may also retain the blind decoding of PBCH DMRS. In other words, there is no ambiguity between PBCH DMRS's (pseudo-)orthogonal extension and another PBCH DMRS.

The PBCH DMRS may be extended by applying OCC or SFBC to a PBCH DMRS in a manner similar to that discussed above with respect to the SSS.

In a system with coexistence of single-port and multi-port BM-RS transmissions, a transmitter may explicitly or implicitly signal to a receiver whether it is using single-port or multi-port BM-RS. This may allow the receiver to conduct proper measurements and report accordingly.

For each Tx analog beam of beam sweeping, the receiver may first estimate the channels, then calculate the BM metric for each precoder hypothesis in the digital codebook. The BM metric may be an RSRP value, a signal-to-interference-plus-noise ratio (SINR) value, etc. The receiver may then identify the precoder that gives the best BM metric outcome. The receiver may continue this process as the Tx analog beam is switched throughout the beam sweeping operation. In this manner, the receiver may obtain a combination of a Tx analog beam and a digital precoder that yields the best BM metric outcome relative to the other measured combinations. The receiver may then report to the transmitter the calculated best BM metric outcome and its associated analog beam index as well as digital precoder index.

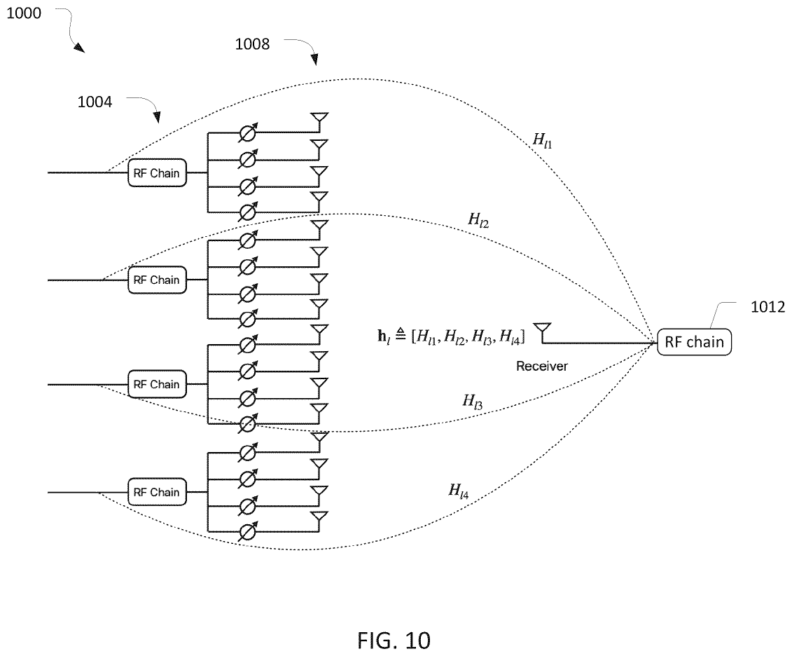

FIG. 10 illustrates a BM-RS transmission 1000 that may serve as a basis for calculating a BM metric in accordance with some embodiments. The BM metric in this embodiment may be RSRP.

The transmitter of FIG. 10 may include four RF chains 1004 (N_{RF}=4) and 16 transmit antennas 1008 (N=16). The receiver of FIG. 10 may include a single Rx chain 1012. Using the BM-RS transmission described previously, for each Tx analog beam of the beam sweeping, the receiver may estimate the channels between the Tx RF chains and the receiver. For example, the receiver may estimate the digital channels from the 4 Tx RF chains as hₗ [symbol] [Hₗ₁, Hₗ₂, Hₗ₃, Hₗ₄] for the l^{th} Tx analog beam in beam sweeping.

The measurement and report may be performed as follows with hₗ [symbol] [Hₗ₁, Hₗ₂, Hₗ₃, Hₗ₄] for the l^{th} Tx analog beam in beam sweeping and a digital codebook of [symbol] ={p₁, p₂, . . . , p₈} with pᵢ=[1, e^{-j2πϕ}^{ᵢ}, . . . , e^{-j2πϕ}^{ᵢ}^{(N}^{_{RF}}⁻¹⁾]^{T} for i∈{1, 2, . . . , 8} and [ϕ₁, ϕ₂, . . . , ϕ₈]=[0, 1, . . . , 7]/8. For the l^{th} Tx analog beam and the i^{th} digital precoder, the receiver may calculate the RSRP as RSRPₗᵢ=∥hᵢpᵢ∥².

The receiver may determine the largest RSRPₗᵢ for all l∈{1, 2, . . . , M₁} and i∈{1, 2, . . . , 8} and report this value along with its associated analog beam index as well as digital precoder index as, for example

$$\{ l , i \} = {arg max}_{l , i} {RSRP}_{li} .$$

In this example, with 8 digital precoders, the report may need an additional log₂(8)=3 bits in order to indicate the index of the preferred digital precoder.

In some embodiments, the receiver can report multiple RSRPs, e.g., the top X RSRP values, and their respective analog beam indexes as well as digital precoder indexes.

The receiver can also report multiple RSRPs, e.g., the top X RSRP values, and the analog beam index as well as digital precoder index associated with the largest RSRP only.

Upon receiving the report, the transmitter may determine the Tx beam for later (data) transmissions using the jointly reported analog beam index and digital precoder index. For example, the best Tx beam may be determined using jointly the analog and digital codebooks with beam

$${\hat{w}}_{Tx} = [ \begin{matrix}{\tilde{b}}_{\hat{l} 1} & & & \\ & {\tilde{b}}_{\hat{l} 2} & & \\ & & … & \\ & & & {\tilde{b}}_{\hat{l} {N}_{RF}}\end{matrix} ] {p}_{\hat{i}} , where {b}_{\hat{l}} = [ \begin{matrix}{\tilde{b}}_{\hat{l} 1} \\ … \\ {\tilde{b}}_{\hat{l} {N}_{RF}}\end{matrix} ] ,$$

\tilde{b}ᵢ₁ is a column vector that include the phase shifters of the antennas associated with the i^{th} RF chain and {l,i} are reported from the receiver.

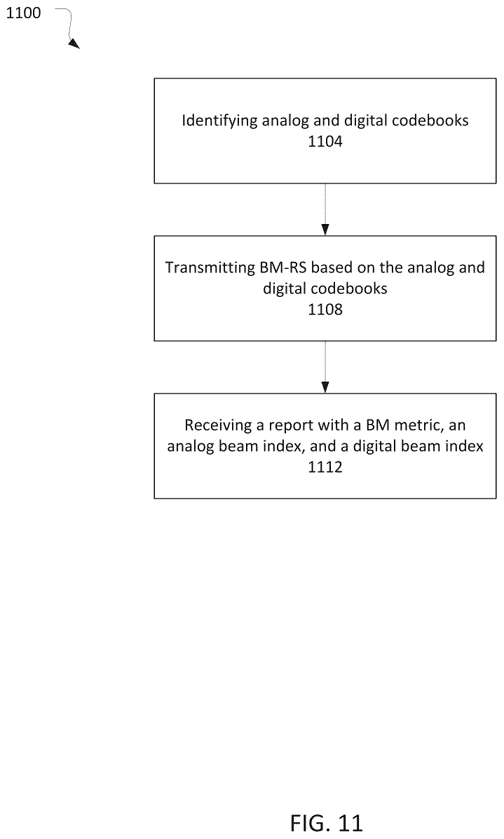

FIG. 11 provides an operation flow/algorithmic structure 1100 in accordance with some embodiments. The operation flow/algorithmic structure 1100 may be performed by a device such as a base station (e.g., base station 108 or base station 1400) or a UE (e.g., UE 104 or UE 1300); or components thereof, for example, processors 1304 or 1404.

The operation flow/algorithmic structure 1100 may include, at 1104, identifying analog and digital codebooks. The analog and digital codebooks may be identified based on objectives or constraints of a particular embodiment. The analog codebook may include a plurality of beamformers, and the digital codebook may include at least two precoders. The digital codebook may be a co-phasing based codebook or a DFT-based codebook. In some embodiments, the transmitter may provide the receiver an indication of the selected digital codebook.

The operation flow/algorithmic structure 1100 may further include, at 1108, transmitting a BM-RS based on the analog and digital codebooks. The BM-RS may be transmitted with the plurality of beam transmissions that respectively correspond to the plurality of beamformer in the analog codebook. Individual beam transmissions may include the BM-RS transmitted across at least two RF chains based on the at least two precoders of the digital codebook. Transmitting the BM-RS across the at least two RF chains may be accomplished by transmitting at least two orthogonal or pseudo-orthogonal BM-RS sequences across the RF chains. The (pseudo-)orthogonality may be provided by applying an OCC or SFBC to the BM-RS to generate the sequences.

The operation flow/algorithmic structure 1100 may further include, at 1112, receiving a report with a BM metric, an analog beam index, and a digital beam index. The BM metric may be the best metric determined by the receiver based on the beam-swept transmissions of the BM-RS. The analog beam index may identify one of the plurality of beamformers and the digital beam index may identify one of the at least two precoders that are associated with the BM metric. In some embodiments, a set of the largest BM metrics may be provided.

The transmitter may select a transmit beam based on the report. In particular, the transmitter may use the identified precoder and beamformer for the hybrid beamforming.

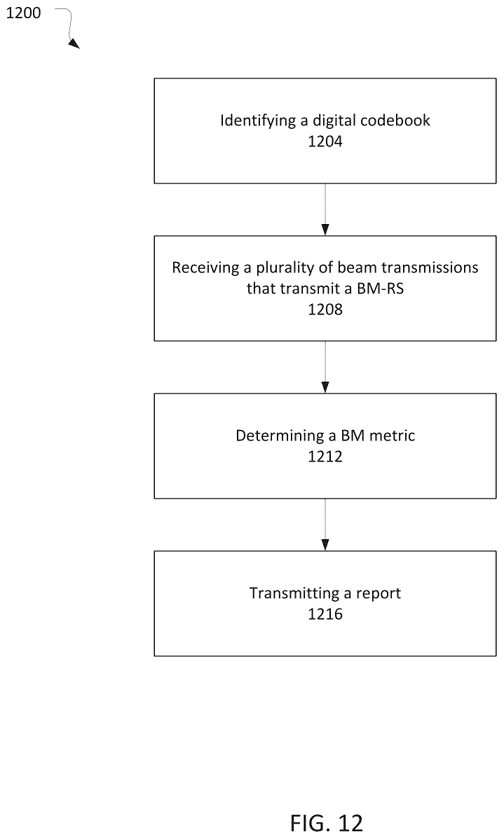

FIG. 12 provides an operation flow/algorithmic structure 1200 in accordance

with some embodiments. The operation flow/algorithmic structure 1200 may be performed by a device such as a UE (e.g., UE 104 or UE 1300) or a base station (e.g., base station 108 or base station 1400); or components thereof, for example, processors 1304 or 1404.

The operation flow/algorithmic structure 1200 may include, at 1204, identifying a digital codebook. The digital codebook may be identified based on explicit or implicit signaling from a transmitter. The digital codebook may be co-phasing based codebook or a DFT-based codebook that includes at least two precoders.

The operation flow/algorithmic structure 1200 may further include, at 1208, receiving a plurality beam transmissions at transmit a BM-RS. For each beam transmission, the device may receive at least two BM-RS sequences based on the at least two precoders of the digital codebook.

The operation flow/algorithmic structure 1200 may further include, at 1212, determining a BM metric. The BM metric, which may be an RSRP value, may be determined by jointly performing an analog beam measurement and digital channel estimation. The BM metric may be associated with a beam transmission of the plurality beam transmissions and a precoder of the least two precoders.

The BM metric determined at 1212 may be selected from a plurality of BM metrics determined based on joint analog beam measurement and digital channel estimation performed on the plurality of beam transmissions. The determined BM metric may be the relatively largest BM metric.

The operation flow/algorithmic structure 1200 may further include, at 1216, transmitting a report. The report may include the determined BM metric, a first index associated with the beam transmission and a second index associated with the precoder.

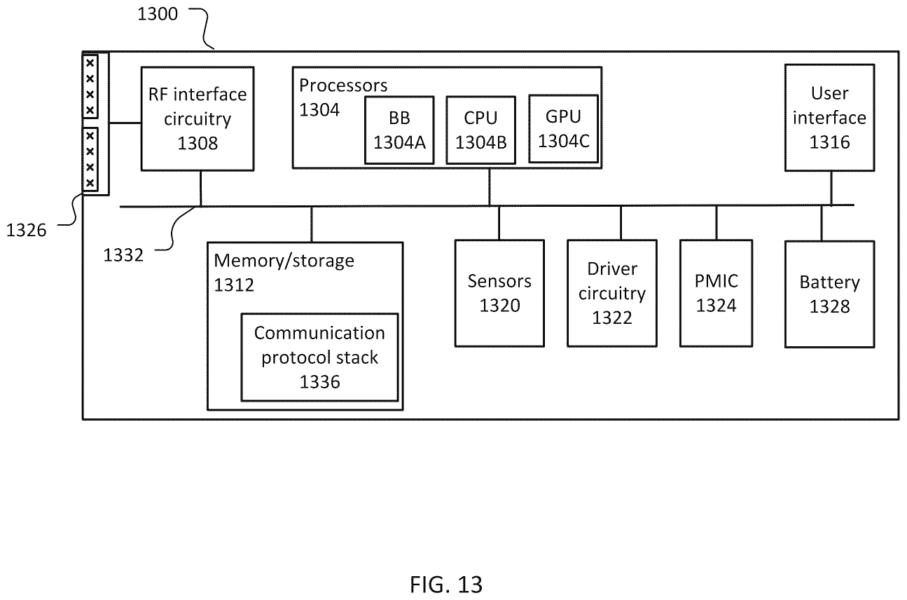

FIG. 13 illustrates an example UE 1300 in accordance with some embodiments. The UE 1300 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 1300 may include processors 1304, RF interface circuitry 1308, memory/storage 1312, user interface 1316, sensors 1320, driver circuitry 1322, power management integrated circuit (PMIC) 1324, antenna structure 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein. The memory/storage 1312 include any type of volatile or non-volatile memory that may be distributed throughout the UE 1300. In some embodiments, some of the memory/storage 1312 may be located on the processors 1304 themselves (for example, L1 and L2 cache), while other memory/storage 1312 is external to the processors 1304 but accessible thereto via a memory interface. The memory/storage 1312 may include any suitable volatile or non-volatile memory such as, but not limited to, dynamic random-access memory (DRAM), static random-access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

The UE 1300 may have a hybrid beamformer having an architecture similar to any of those discussed elsewhere herein. In some embodiments, some portions of the hybrid beamformer may be included in the processors 1304, while other portions may be included in the RF interface circuitry. For example, a digital precoder of the hybrid beamformer may be implemented in the baseband processor circuitry 1304A, while the RF chains and the analog beamformer may be implemented in the RF interface circuitry 1308.

In the receive path, the RFEM may receive a radiated signal from an air interface via antenna structure 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1326.

In various embodiments, the RF interface circuitry 1308 may be configured to transmit/receive signals in a manner compatible with NR access technologies.

The antenna structure 1326 may include antenna elements to convert electrical signals into radio waves to travel through the air and to convert received radio waves into electrical signals. The antenna elements may be arranged into one or more antenna panels.

The antenna structure 1326 may have antenna panels that are omnidirectional, directional, or a combination thereof to enable beamforming and multiple-input, multiple-output communications. The antenna structure 1326 may include microstrip antennas, printed antennas fabricated on the surface of one or more printed circuit boards, patch antennas, phased array antennas, etc. The antenna structure 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensors 1320 and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC Connected state, where it is still connected to the RAN node as it expects to receive traffic shortly, then it may enter a state known as Discontinuous Reception Mode (DRX) after a period of inactivity. During this state, the UE 1300 may power down for brief intervals of time and thus save power. If there is no data traffic activity for an extended period of time, then the UE 1300 may transition off to an RRC Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted or deployed in a fixed location and may have a power supply coupled to an electrical grid. The battery 1328 may be a lithium-ion battery or a metal-air battery such as a zinc-air battery, an aluminum-air battery, a lithium-air battery, and the like. In some implementations, such as in vehicle-based applications, the battery 1328 may be a typical lead-acid automotive battery.

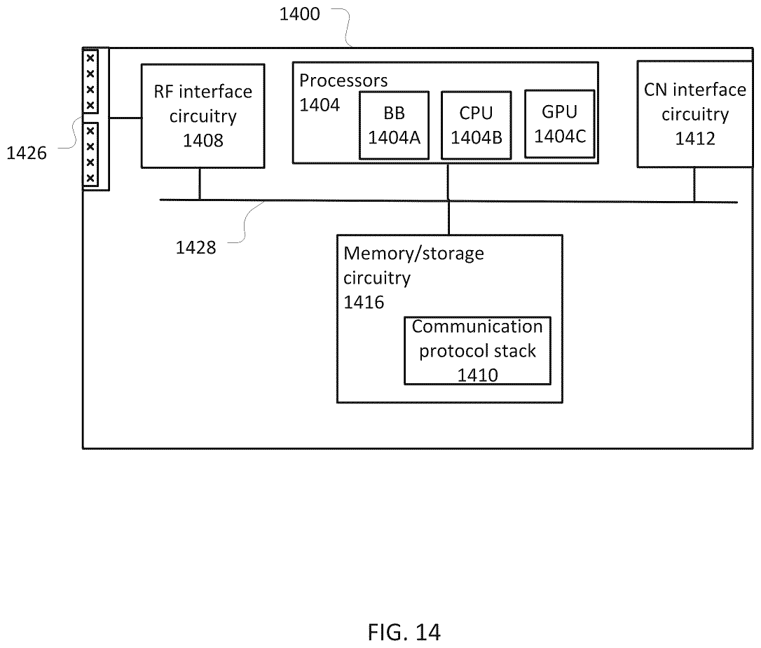

FIG. 14 illustrates an example base station 1400 in accordance with some embodiments. The base station 1400 may be a base station or an AMF as describe elsewhere herein. The base station 1400 may include processors 1404, RF interface circuitry 1408, core network (CN) interface circuitry 1412, memory/storage circuitry 1416, and antenna structure 1426. The RF interface circuitry 1408 and antenna structure 1426 may not be included when the base station 1400 is an AMF.

The components of the base station 1400 may be coupled with various other components over one or more interconnects 1428.

The processors 1404, RF interface circuitry 1408, memory/storage circuitry 1416 (including communication protocol stack 1410), antenna structure 1426, and interconnects 1428 may be similar to like-named elements shown and described with respect to FIG. 13. Further, the base station 1400 may include a hybrid beam former implemented in components such as, for example, processors 1404 and RF interface circuitry 1408 in a manner similar to that discussed above with respect to FIG. 13.

The CN interface circuitry 1412 may provide connectivity to a core network, for example, a 5th Generation Core network (5GC) using a 5GC-compatible network interface protocol such as carrier Ethernet protocols, or some other suitable protocol. Network connectivity may be provided to/from the base station 1400 via a fiber optic or wireless backhaul. The CN interface circuitry 1412 may include one or more dedicated processors or FPGAs to communicate using one or more of the aforementioned protocols. In some implementations, the CN interface circuitry 1412 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: identifying an analog codebook having a plurality of beamformers; identifying a digital codebook having at least two precoders; and transmitting a beam management-reference signal (BM-RS) with a plurality of beam transmissions that respectively correspond to the plurality of beamformers, wherein for individual beam transmissions of the plurality of beam transmissions, transmitting the BM-RS includes transmitting the BM-RS across at least two radio-frequency (RF) chains based on the at least two precoders, respectively.

Example 2 includes a method of example 1 or some other example herein, wherein transmitting the BM-RS across the at least two RF chains based on the at least two precoders further comprises: transmitting at least two orthogonal or pseudo-orthogonal BM-RS sequences across the at least two RF chains.

Example 3 includes a method of example 2 or some other example herein, further comprising: applying an orthogonal cover code (OCC) or a space frequency block coding (SFBC) to the BM-RS to generate the at least two orthogonal or pseudo-orthogonal BM-RS sequences.

Example 4 includes the method of example 1 or some other example herein, further comprising: transmitting an indication of whether transmission of the BM-RS is with a single port or a plurality of ports.

Example 5 includes a method of example 1 or some other example herein, further comprising: receiving a report that includes a beam management (BM) metric, an analog beam index to identify one of the plurality of beamformers; and a digital beam index to identify one of the at least two precoders.

Example 6 includes a method of example 5 or some other example herein, further comprising: selecting a transmit beam based on the report.

Example 7 includes the method of any one of examples 1-6 or some other example herein, wherein the digital codebook is a co-phasing based codebook or a discrete Fourier transform (DFT)-based codebook.

Example 8 includes the method of any one of examples 1-6 or some other example herein, further comprising: transmitting, to a user equipment (UE), an indication of the digital codebook.

Example 9 includes the method of any one of examples 1-6 or some other example herein, wherein the BM-RS is a secondary synchronization signal (SSS) or a physical broadcast channel (PBCH) demodulation reference signal (DMRS).

Example 10 includes a method of operating a device comprising: identifying a digital codebook having at least two precoders; receiving a plurality of beam transmissions that transmit a beam management-reference signal (BM-RS), wherein for individual beam transmissions of the plurality of beam transmissions, the device is to receive at least two BM-RS sequences based on the at least two precoders, respectively; determining a beam management (BM) metric by jointly performing an analog beam measurement and digital channel estimation, wherein the BM metric is associated with a beam transmission of the plurality of beam transmissions and a precoder of the at least two precoders; and transmitting a report that includes a first index associated with the beam transmission and a second index associated with the precoder.

Example 11 includes the method of example 10 or some other example herein, wherein the report further includes the BM metric.

Example 12 includes the method of example 10 or some other example herein, wherein the BM metric is a reference signal receive power (RSRP) value or a signal-to-interference-plus-noise ratio (SINR) value.

Example 13 includes the method of example 10 or some other example herein, wherein, for individual beam transmissions of the plurality of beam transmissions, the method comprises: estimating at least two channels between at least two radio frequency (RF) chains of the device and a receiver based on the at least two precoders.

Example 14 includes the method of example 10 or some other example herein, further comprising: calculating a plurality of BM metrics corresponding to the plurality of beam transmissions and the at least two precoders; and selecting the BM metric from the plurality of BM metrics based on the BM metric being a largest of the plurality of BM metrics.

Example 15 includes the method of any one of examples 10-14 or some other example herein, wherein the at least two BM-RS sequences are at least two orthogonal or pseudo-orthogonal BM-RS sequences generated by applying an orthogonal cover code (OCC) or a space frequency block coding (SFBC) to the BM-RS.

Example 16 includes the method of any one of examples 10-14 or some other example herein, wherein the digital codebook is a co-phasing based codebook or a discrete Fourier transform (DFT)-based codebook.

Example 17 includes the method of any one of examples 10-14 or some other example herein, wherein the BM-RS is a secondary synchronization signal (SSS) or a physical broadcast channel (PBCH) demodulation reference signal (DMRS).

Example 18 includes an apparatus comprising: a hybrid beamformer having a digital precoder, at least two radio-frequency (RF) chains, and an analog beamformer; processing circuitry coupled with the hybrid beamformer, the processing circuitry to identify an analog codebook having a plurality of beamformers; identify a digital codebook having at least two precoders; and cause the hybrid beamformer to transmit a beam management-reference signal (BM-RS) with a plurality of beam transmissions that respectively correspond to the plurality of beamformers, wherein for individual beam transmissions of the plurality of beam transmissions, the BM-RS is to be transmitted across the at least two RF chains based on the at least two precoders, respectively.

Example 19 includes the apparatus of example 18 or some other example herein, wherein to cause the hybrid beamformer to transmit the BM-RS the processing circuitry is further to cause the hybrid beamformer to: transmit at least two orthogonal or pseudo-orthogonal BM-RS sequences across the at least two RF chains.

Example 20 includes the apparatus of example 19 or some other example herein, wherein the processing circuitry is further to: apply an orthogonal cover code (OCC) or a space frequency block coding (SFBC) to the BM-RS to generate the at least two orthogonal or pseudo-orthogonal BM-RS sequences.

Example 21 includes the apparatus of example 20 or some other example herein, wherein the processing circuitry is further to: receive a report that includes a beam management (BM) metric, an analog beam index to identify one of the plurality of beamformers; and a digital beam index to identify one of the at least two precoders; and select a transmit beam based on the report

Example 22 may include an apparatus comprising means to perform one or more elements of a method described in or related to any of examples 1-21, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 24 may include an apparatus comprising logic, modules, or circuitry to perform one or more elements of a method described in or related to any of examples 1-21, or any other method or process described herein.

Example 25 may include a method, technique, or process as described in or related to any of examples 1-21, or portions or parts thereof

Example 26 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example 27 may include a signal as described in or related to any of examples 1-21, or portions or parts thereof

Example 28 may include a datagram, information element, packet, frame, segment, PDU, or message as described in or related to any of examples 1-21, or portions or parts thereof, or otherwise described in the present disclosure.

Example 29 may include a signal encoded with data as described in or related to any of examples 1-21, or portions or parts thereof, or otherwise described in the present disclosure.

Example 30 may include a signal encoded with a datagram, IE, packet, frame, segment, PDU, or message as described in or related to any of examples 1-21, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or portions thereof

Example 32 may include a computer program comprising instructions, wherein execution of the program by a processing element is to cause the processing element to carry out the method, techniques, or process as described in or related to any of examples 1-21, or portions thereof

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed.

Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a base station, the method comprising:
identifying an analog codebook having a plurality of beamformers;
identifying a digital codebook having at least two precoders; and
transmitting a beam management-reference signal (BM-RS) with a plurality of beam transmissions that respectively correspond to the plurality of beamformers,
wherein for individual beam transmissions of the plurality of beam transmissions, transmitting the BM-RS includes transmitting the BM-RS across at least two radio-frequency (RF) chains based on the at least two precoders, respectively.

2. The method of claim 1, wherein transmitting the BM-RS across the at least two RF chains based on the at least two precoders further comprises:
transmitting at least two orthogonal or pseudo-orthogonal BM-RS sequences across the at least two RF chains.

3. The method of claim 2, further comprising:
applying an orthogonal cover code (OCC) or a space frequency block coding (SFBC) to the BM-RS to generate the at least two orthogonal or pseudo-orthogonal BM-RS sequences.

4. The method of claim 1, further comprising:
transmitting an indication of whether transmission of the BM-RS is with a single port or a plurality of ports.

5. The method of claim 1, further comprising:
receiving a report that includes a beam management (BM) metric, an analog beam index to identify one of the plurality of beamformers; and a digital beam index to identify one of the at least two precoders.

6. The method of claim 5, further comprising:
selecting a transmit beam based on the report.

7. The method of claim 1, wherein the digital codebook is a co-phasing based codebook or a discrete Fourier transform (DFT)-based codebook.

8. The method of claim 1, further comprising:
transmitting, to a user equipment (UE), an indication of the digital codebook.

9. The method of claim 1, wherein the BM-RS is a secondary synchronization signal (SSS) or a physical broadcast channel (PBCH) demodulation reference signal (DMRS).

10. One or more non-transitory, computer-readable media having instructions that, when executed, cause a device to:
identify a digital codebook having at least two precoders;
receive a plurality of beam transmissions that transmit a beam management-reference signal (BM-RS), wherein for individual beam transmissions of the plurality of beam transmissions, the device is to receive at least two BM-RS sequences based on the at least two precoders, respectively;
determine a beam management (BM) metric by jointly performing an analog beam measurement and digital channel estimation, wherein the BM metric is associated with a beam transmission of the plurality of beam transmissions and a precoder of the at least two precoders; and
transmit a report that includes a first index associated with the beam transmission and a second index associated with the precoder.

11. The one or more non-transitory, computer-readable media of claim 10, wherein the report further includes the BM metric.

12. The one or more non-transitory, computer-readable media of claim 10, wherein the BM metric is a reference signal receive power (RSRP) value or a signal-to-interference-plus-noise ratio (SINR) value.

13. The one or more non-transitory, computer-readable media of claim 10, wherein, for individual beam transmissions of the plurality of beam transmissions, the instructions, when executed, cause the device to:
estimate at least two channels between at least two radio frequency (RF) chains of the device and a receiver based on the at least two precoders.

14. The one or more non-transitory, computer-readable media of claim 10, wherein the instructions, when executed, further cause the device to:
calculate a plurality of BM metrics corresponding to the plurality of beam transmissions and the at least two precoders; and
select the BM metric from the plurality of BM metrics based on the BM metric being a largest of the plurality of BM metrics.

15. The one or more non-transitory, computer-readable media of claim 10, wherein the at least two BM-RS sequences are at least two orthogonal or pseudo-orthogonal BM-RS sequences generated by applying an orthogonal cover code (OCC) or a space frequency block coding (SFBC) to the BM-RS.

16. The one or more non-transitory, computer-readable media of claim 10, wherein the digital codebook is a co-phasing based codebook or a discrete Fourier transform (DFT)-based codebook.

17. The one or more non-transitory, computer-readable media of claim 10, wherein the BM-RS is a secondary synchronization signal (SSS) or a physical broadcast channel (PBCH) demodulation reference signal (DMRS).

18. An apparatus comprising:
a hybrid beamformer having a digital precoder, at least two radio-frequency (RF) chains, and an analog beamformer;
processing circuitry coupled with the hybrid beamformer, the processing circuitry to
identify an analog codebook having a plurality of beamformers;
identify a digital codebook having at least two precoders; and
cause the hybrid beamformer to transmit a beam management-reference signal (BM-RS) with a plurality of beam transmissions that respectively correspond to the plurality of beamformers,
wherein for individual beam transmissions of the plurality of beam transmissions, the BM-RS is to be transmitted across the at least two RF chains based on the at least two precoders, respectively.

19. The apparatus of claim 18, wherein to cause the hybrid beamformer to transmit the BM-RS the processing circuitry is further to cause the hybrid beamformer to:
apply an orthogonal cover code (OCC) or a space frequency block coding (SFBC) to the BM-RS to generate at least two orthogonal or pseudo-orthogonal BM-RS sequences; and
transmit the at least two orthogonal or pseudo-orthogonal BM-RS sequences across the at least two RF chains.

20. The apparatus of claim 18, wherein the processing circuitry is further to:
receive a report that includes a beam management (BM) metric, an analog beam index to identify one of the plurality of beamformers; and a digital beam index to identify one of the at least two precoders; and
select a transmit beam based on the report.
